(19) United States
(12) Patent Application Publication
(10) Pub. No.: US 2012/0254750 A1
(43) Pub. Date: Oct. 4, 2012

(54) APPARATUS, SYSTEMS, AND METHODS FOR AUTOMATICALLY CHANGING THEMES OF A MEDIA DEVICE

(75) Inventor: Brett Chessher, Littleton, CO (US)

(73) Assignee: EchoStar Technologies L.L.C., Englewood, CO (US)

(21) Appl. No.: 13/077,717

(22) Filed: Mar. 31, 2011

(51) Int. Cl. G06F 3/00

(52) U.S. Cl. 715/716

(57) ABSTRACT

Systems and methods for automatically altering a user interface. An exemplary method receives at a media device a request to display a user interface associated with the received user interface information, receives current date information, accesses display style information based on the current date information and generates the requested user interface based on the accessed display style information. The accessed display style information is retrieved from memory associated with the media device or is received from a source system over a communication network.

### BACKGROUND

Media devices, such as a set-top box, a stereo, a television, a computer system, a game system, or the like, are often configured to receive media content events. A media content event is communicated as part of a media content stream that includes a video stream portion and an audio stream portion. Nonlimiting examples of media content events communicated in a media content stream include, but are not limited to, a television program, a newscast, a broadcast sports event, a movie, or the like.

These media devices include user interface menus, such as the electronic program guide (EPG), that include the ability for a viewer to view and access the media content. The user interface menus typically default to a standard font and color. It may be possible to manually change the font and color, but is difficult and inconvenient.

Accordingly, there is a need in the arts to provide a more user-friendly experience with interfaces provided with a media content stream.

### SUMMARY

The present invention provides systems and methods for automatically altering a user interface. An exemplary method receives at a media device a request to display a user interface associated with the received user interface information, receives current date information, accesses display style information based on the current date information and generates the requested user interface based on the accessed display style information. The accessed display style information is retrieved from memory associated with the media device or is received from a source system over a communication network.

In one aspect, the received display style information includes a plurality of themes. Each of the themes may include a font type pertaining to the theme. The themes are associated with at least one of a specific day of the year or a range of days of the year. The specific day or the range of days includes at least one of the following days: Halloween, Thanksgiving Day, Christmas Day, Valentines Day, St. Patrick's Day, Easter, July 4^{th} or non-USA holidays. The themes may include nontext images and audio files.

### BRIEF DESCRIPTION OF THE DRAWINGS

Preferred and alternative embodiments are described in detail below with reference to the following drawings:

FIG. 1 is a block diagram of an embodiment of an exemplary media device;

FIG. 2 illustrates an exemplary media content stream and user interface presented on a display device associated with a media device;

FIG. 3 is an exemplary screen shot of an electronic program guide (EPG) adapted in accordance with an exemplary embodiment; and

FIG. 4 illustrates a streaming media content with associated program information displayed in accordance with an exemplary embodiment.

### DETAILED DESCRIPTION

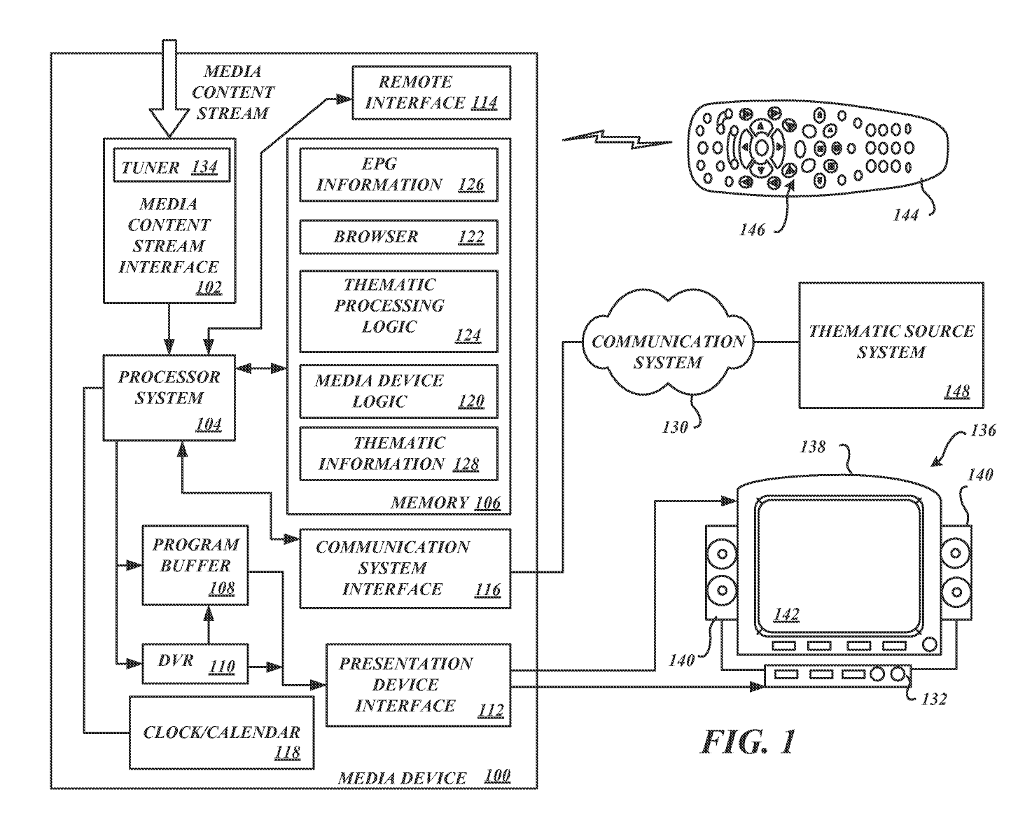

A media content provider provides media content that is received in one or more media content streams. A media content stream typically includes a plurality of media content events multiplexed together. The one or more media content streams are communicated to a media device 100 (FIG. 1) from a media system sourced from a remote head-end facility (not shown) operated by the content service provider. Non-limiting examples of such media systems include satellite systems, cable system, and the Internet. For example, if the service provider provides programming via a satellite-based communication system, the media device 100 is configured to receive one or more broadcasted satellite signals detected by an antenna (not shown). Alternatively, or additionally, the media content stream can be received from one or more different sources, such as, but not limited to, a cable system, a radio frequency (RF) communication system, or the Internet.

FIG. 1 is a block diagram of an embodiment of an exemplary media device 100. The nonlimiting exemplary media device 100 includes a media content stream interface 102, a processor system 104, a memory 106, a program buffer 108, an optional digital video recorder (DVR) 110, a presentation device interface 112, a remote interface 114, an optional communication system interface 116, and a clock/calendar device 118. The memory 106 stores media device logic 120, a browser 122, thematic processing logic 124, electronic program guide (EPG) information 126, and thematic information 128. In other embodiments, some or all of these memory and other data manipulation functions may be provided by using a remote server or other electronic devices suitably connected via the Internet (a communication system 130) or otherwise to the media device 100. Other media devices 100 may include some, or may omit some, of the above-described media-processing components. Further, additional components not described herein may be included in alternative embodiments.

The thematic information 128 includes font styles and/or graphics for one or more different predefined themes of a user interface. The thematic information 128 may be prestored into memory or may be received on demand from a remote source. The thematic information 128 is used by the processor system 104 in order to alter the theme of nonstreaming content user interfaces (i.e., EPG, user interface menus, browser etc.) according to the thematic processing logic 124.

The thematic information 128 may also include audio files. The audio files may be associated with the font styles and/or graphics. In one embodiment, the processor system 104 plays an audio file through the audio presentation device 132 simultaneously (or separately) with the displayed nonstreaming content user interfaces.

In an exemplary embodiment, the media content stream is received by the media content stream interface 102. One or more tuners 134 in the media content stream interface 102 selectively tune to a particular media content stream in accordance with instructions received from the processor system 104. The processor system 104, executing the media device logic 120 and based upon a request for a media content event of interest specified by a user, parses out the media content event of interest. The media content event of interest is then assembled into a stream of video and/or audio information, which may be stored by the program buffer 108 such that the media content event can be streamed out to the media presentation system 136, via the presentation device interface 112. Alternatively, or additionally, the parsed-out media content event may be saved into the DVR 110 for later presentation. The DVR 110 may be directly provided in, locally connected to, or remotely connected to, the media device 100.

In one embodiment, the presentation device interface 112 is illustrated as being coupled to the media presentation system 136 that includes a visual display device 138, such as a television (hereafter, generically, a TV), and an audio presentation device 132, such as a surround-sound receiver (with one or more speakers 140). Other types of output devices may also be coupled to the media device 100, including those providing any sort of human stimuli, such as temperature, vibration, and the like. The video portion of the streamed program content is displayed on a display 142 and the audio portion of the streamed program content is reproduced as sounds by a plurality of speakers 140.

From time to time, information populating the EPG information 126 portion of the memory 106 is communicated to the media device 100. The EPG information 126 stores information pertaining to the scheduled programming for the media content events. The information may include, but is not limited to, a scheduled presentation start and/or end time, a program channel, and descriptive information of the media content events. The descriptive information of the media content events may include the title, names of performers or actors, date of creation, a summary describing the nature of the media content event and thematic information. Upon receipt of a command from the user requesting presentation of an EPG, the information in the EPG information 126 is retrieved, formatted based on received or previously stored thematic information 128 and current date/time information received from a clock/calendar device 118 (or received from the EPG), and then presented on the display 142.

The exemplary media device 100 receives commands from a user via control device (e.g., a remote control 144). The remote control 144 includes one or more controllers 146. The user, by actuating one or more of the controllers 146, causes the remote control 144 to generate and transmit commands, via a wireless signal, to the media device 100. The commands control the media device 100 and/or the media presentation system 136. The wireless signal may be an infrared signal or an RF signal.

The above processes performed by the media device 100 are generally implemented by the processor system 104 while executing the media device logic 120 and the thematic processing logic 124. Thus, the media device 100 may perform a variety of functions relating to the processing and presentation of the media content event.

The communication system interface 116 is configured to provide connectivity of the media device 100 to other remote devices (e.g., the media content delivery system, a third party provider) via the communication system 130. In an exemplary embodiment that is configured with Internet connectivity, the communication system interface 116 is a suitable modem, or a device configured to connect to a modem. For example, the browser 122 is used to access and/or retrieve the thematic information 128 from a remote site, such as a Web site (third party provider) and/or the exemplary thematic source system 148. Additionally, or alternatively, the retrieved thematic information 128 may be stored by the media device 100, such as in the DVR 110, memory 106, or another suitable memory medium. The communication system interface 116 may be any suitable device that is configured to provide connectivity of the media device 100 to the communication system 130.

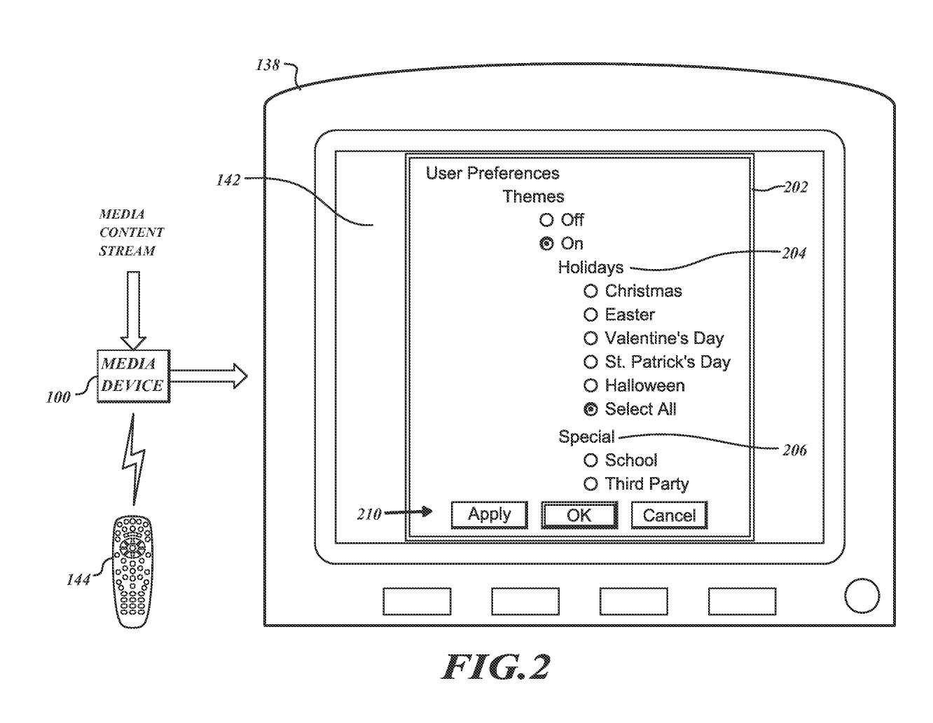

FIG. 2 shows the media device 100 having received the media content stream and command signals from the remote control 144. In this conceptual example, a user of the remote control 144 has activated the remote control 144 to present a user preference screen 202, an exemplary user interface. The user preference screen 202 allows the user to activate (on) or deactivate (off) themes. If the user has selected to deactivate the themes, then the thematic information 128 and thematic processing logic 124 are not used by the processor system 104 for generation and display of the nonstreaming content user interfaces (e.g., EPG, browser 122, other menus, etc.). If themes are not selected by the user, then default fonts are automatically selected by the processor system 104 when generating the nonstreaming content user interfaces and the processor system 104 do not access date information from the clock/calendar 118 or date information included in the media content stream.

The user may activate the themes by selecting an “On” indicator or the like. In an exemplary embodiment, selectable indicators may be buttons located adjacent to theme choices in the user preferences screen 202. In response to the selection, the processor system 104 may present the various nonstreaming content user interfaces according to the selected themes if the date information received from the clock/calendar 118 corresponds to one of the selected themes according to the thematic processing logic 124. Each theme is associated with date information (i.e., a day or range of days).

In one embodiment, the thematic processing logic 124 determines which of the stored thematic information 128 is used for altering the output of the user interface content every time the nonstreaming content user interface is ready to be displayed or commanded to be displayed. In another embodiment, the thematic processing logic 124 does not require the date information from the clock/calendar 130 every time the nonstreaming content user interface is to be displayed.

The user preferences screen 202 includes a holiday section 204 and a special section 206. The holiday section 204 allows a user to select one or more predefined holiday themes (i.e., display styles) that are stored in the thematic information 128 or is retrieved in real time from the thematic source system 148 over the communication system 130.

The special section 206 allows a user to select from nonholiday themes that may be stored in the thematic information 128. Alternatively, or additionally, the thematic source system 148 is retrieved in real time over the communication system 130 after the selection. The special section 206 may include themes relating to a school, a pro sports team or some other theme provided by a third-party provider.

In an exemplary embodiment, selection of the school theme will retrieve thematic information over the communication system 130 from a provider associated with a specific school identified after user selection of the school. For example, the user selects the school item from the special section 206, which then presents a drop-down menu of a plurality of participating schools. Selection of one of the schools from the participating schools will cause the processor system 104 to send a request to thematic source system 148 (i.e., the school associated with the selection) via the communication system 130. The school will then reply with thematic information that is sent back through the communication system 130 to the processor system 104 that then stores it into the thematic information 128 of the memory 106. The processor system 104 then retrieves the school theme and alters the nonstreaming content user interface according to the school theme information. Alternatively, or additionally, a provider (system 148) other than the school can provide the school theme information upon request. The special section 206 may include or retrieve themes associated with previously stored user information (e.g., college attended, city of address for local sports teams).

The thematic information 128 may also include audio files. If audio files are present within the thematic information 128, the processor system 104 retrieves the audio file and outputs it via the audio presentation device 132, either at the same time that the nonstreaming content user interface is being displayed or at any time when the broadcast content is not being displayed according to the thematic processing logic 124. Audio files may also be retrieved from a provider, either passively or actively, upon request.

The special section 206 may also include third-party themes. Selection of the third-party themes allows a user to go to any participating third parties for retrieving previously generated themes. Third-party themes may be any theme. For example, the third-party themes may provide variations of the holiday themes or provide unique themes, e.g., TV show themes, birthday themes, special day or month themes. Some themes may require the processor system 104 to access user personal information to determine if a selected theme is to be applied to the nonstreaming content user interface. The themes provided in the special section 206 may or may not be associated with date information. In other words, they may be presented any time if not associated with date information unless a holiday theme has been activated for use.

The personal information (city/state of location, etc.) could also be used to update the special section 206. For example, if the personal information indicates the user is located in New Orleans, La., then a selectable special theme that is added could be LSU football or Saints Football. The Holiday list may be updated as well based on personal information. For example, Mardi Gras is added for a New Orleans resident.

In an exemplary embodiment, at the bottom of the user preference screen 202 are user interface buttons 210. Alternatively, or additionally, buttons 210 may be presented elsewhere on the display. In the exemplary embodiment, the user interface buttons 210 include an Apply button, an OK button, and a Cancel button. When a user activates the Apply button, then a theme is applied if selected and if the associated date (if applicable) matches the actual date or is within a range of dates. The theme is applied to the text displayed in the user preference screen 202. The theme may be applied regardless of date, so that the user gets to see the theme's effects. Activation of the OK button applies the selections in the user preferences screen 202, like the Apply button, but simultaneously closes the user preference screen 202. The Cancel button accepts no selection in the user preference screen 202 that alters a previously stored selection.

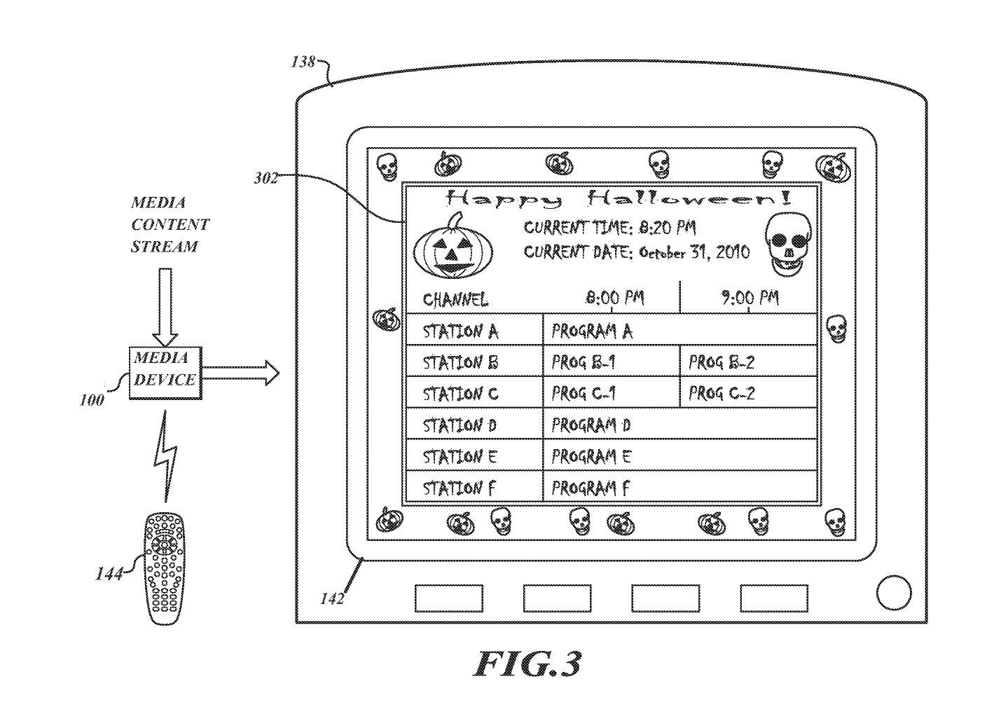

FIG. 3 illustrates an exemplary theme-based EPG 302 that is presented on the visual display device 138 of the media presentation system 136. In this example, the user has selected all of the holidays from the Holiday section 204 of the user preferences screen 202. Further, the user has selected the EPG 302 for display using the remote control 144. The processor system 104 using the thematic processing logic 124, before displaying the EPG 302, compares date information received from the clock/calendar 130 to what the user has selected in the user preferences screen 202. As shown at the top of the EPG 302, the date is Oct. 31, 2010. The processor system 104 selects the Halloween theme because the present date corresponds to the Halloween theme stored in the thematic information 128. The font for the nonstreaming content user interface is then altered according to the Halloween theme. Audio output and other images associated with the Halloween theme may be outputted as well.

When the user requests the EPG 302 for display on Nov. 1, 2010, the processor 104 will not retrieve the Halloween theme or any other holiday theme from the thematic information 128 because the current date information received from the clock/calendar 130 no longer corresponds to a holiday theme. On November 1, a default or special theme defines the look of the nonstreaming content user interface.

In summary, there are many ways that the thematic information 128 may be delivered to the media device 100. The thematic information 128 can be transported with the media content stream and/or transported with the EPG information. The thematic information 128 can come prior to delivery of the media content stream via a back channel to the media content provider. Alternatively, or additionally, the thematic information 128 is delivered via a communication network (similar to back channel) to a third party provider. Alternatively, the thematic information 128 can come on-demand from the media content provider via the back channel or from the third party provider via the communication network.

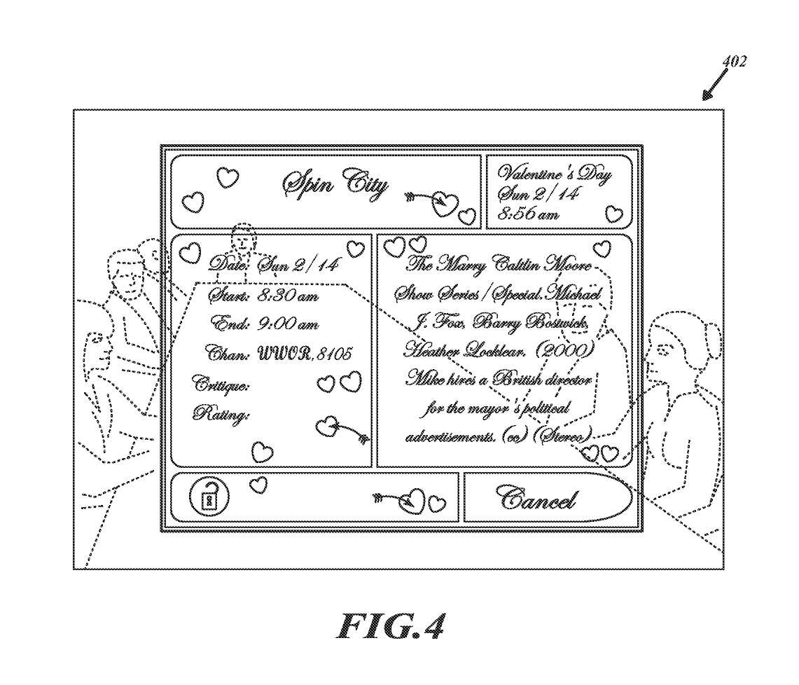

FIG. 4 is a screen shot 402 of a media content event (the show Spin City) with information associated with the media content event displayed transparently over the media content event. The style of how the information associated with the media content event is based on a Valentine's Day theme. The thematic processing logic 124 and the processor system 104 altered the style of the information received via the media content stream because the user had previously activated the theme feature as described above. Because the processor system 104 had determined that the date is February 14, the alteration of the style to the Valentine's Day theme occurs.

It should be emphasized that the above-described embodiments of the video information and acquisition system are merely possible examples of implementations of the invention. Many variations and modifications may be made to the above-described embodiments. All such modifications and variations are intended to be included herein within the scope of this disclosure and protected by the following claims.

We claim:

1. A method of automatically altering a user interface, the method comprising:
receiving a request to display a user interface associated with the received user interface information;
receiving current date information;
accessing display style information based on the current date information; and
generating the requested user interface based on the accessed display style information.

2. The method of claim 1, wherein accessing the display style information comprises retrieving the display style information from a memory of a media device.

3. The method of claim 1, wherein accessing the display style information comprises receiving the display style information at a media device over a communication network.

4. The method of claim 1, wherein the received display style information comprises a plurality of themes, each of the themes comprising a font type pertaining to the theme.

5. The method of claim 1, further comprising:
receiving the display style information in a received media content stream.

6. The method of claim 1, further comprising:
establishing a communication link to a thematic source system;
requesting the display style information from the thematic source system; and
receiving the display style information from the thematic source system.

7. The method of claim 1, wherein each of the themes is uniquely associated with a specific day of the year.

8. The method of claim 7, wherein the specific day includes at least one of the following days: Halloween, Thanksgiving Day, Christmas Day, Easter, St. Patricks Day, Valentine's Day, Mardi Gras, July 4^{th} or a non-USA holiday.

9. The method of claim 1, wherein each of the themes is uniquely associated with a range of days of the year.

10. The method of claim 9, wherein the range of days includes a predefined number of days associated with at least one of the following days: Halloween, Thanksgiving Day, Christmas Day, Easter, or July 4^{th}.

11. The method of claim 1, wherein the themes comprise at least one nontext image pertaining to the theme.

12. The method of claim 1, wherein the themes comprises at least one audio files pertaining to the theme.

13. A system for automatically altering a user interface, the system comprising:
a tuner configured to receive a first one of a plurality of media content streams and user interface information;
a remote interface configured to receive a request to display a user interface associated with the received user interface information based on a received user command annunciated from a user control device;
a processor system communicatively coupled to the tuner and the remote interface, the processor system configured to:
receive a request to display a user interface associated with the received user interface information;
receive current date information;
access display style information based on the current date information; and
generate the requested user interface based on the accessed display style information.

14. The system of claim 13, further comprising:
a memory communicatively coupled to the processor system, the memory configured to store the display style information,
wherein the processor system generates the user interface further based on stored display style information.

15. The system of claim 13, further comprising:
a communication interface communicatively coupled to the processor system,
wherein the communication interface is configured to receive display style information from at least one of a streaming media content system and a third party system via a network.

16. The system of claim 13, wherein the display style information comprises a plurality of themes, each of the themes comprising a font type.

17. The system of claim 16, wherein each of the themes is associated with at least one of a specific day of the year or a range of days of the year.

18. The system of claim 17, wherein the at least one of the specific day or the range of days includes at least one of the following days: Halloween, Thanksgiving Day, Christmas Day, Easter, St. Patricks Day, Valentine's Day, Mardi Gras, July 4^{th} or a non-USA holiday.

19. A method for automatically altering a user interface, the method comprising:
at a media device,
receiving a display style selection from a user;
receiving a request for a user interface for display from the user;
receiving current date information;
accessing display style information based on the current date information; and
generating the requested user interface based on the accessed display style information.

20. The method of claim 19, wherein the selected display style comprises a plurality of themes, each of the themes comprising a font type pertaining to the theme, wherein the plurality of themes is based upon personal information associated with a user.
